(19) United States
(12) Patent Application Publication
(10) Pub. No.: US 2009/0266298 A1
(43) Pub. Date: Oct. 29, 2009

(54) PLASMA DOPING APPARATUS

(76) Inventors: Katsumi Okashita, Osaka (JP); Yuichiro Sasaki, Osaka (JP); Bunji Mizuno, Nara (JP)

Correspondence Address: MCDERMOTT WILL & EMERY LLP, 600 13TH STREET, NW, WASHINGTON, DC, 20005-3096, US

(21) Appl. No.: 12/430,551

(22) Filed: Apr. 27, 2009

(30) Foreign Application Priority Data
Apr. 28, 2008 (JP) 2008-116835

(51) Int. Cl. B05C 11/00

(52) U.S. Cl. 118/712

(57) ABSTRACT

On an upper wall of a vacuum container opposing a sample electrode, a plasma-invasion prevention-and-electron beam introducing hole is installed which is communicated with an electron beam introducing tube, and is used for introducing an electron beam toward a substrate in the vacuum container, as well as for preventing invasion of plasma into the electron beam introducing tube. In this structure, supposing that the Debye length of the plasma is set to λ_{d} and that a thickness of the sheath is set to S_{d}, the electron beam introducing hole has a diameter D satisfying a following equation: D≦2λ_{d}+2S_{d}.

### BACKGROUND OF THE INVENTION

The present invention relates to a plasma doping apparatus used in a semiconductor device and a manufacturing method thereof, and in particular, used for introducing an impurity into a surface of a solid-state sample such as a semiconductor substrate.

As a technique for introducing an impurity into a surface of a solid-state sample, there has been known a plasma doping method in which the impurity is ionized and introduced into the solid-state sample in a low energy state (for example, see International Publication No. WO/2006/098109 (Japanese Patent Application No. 2005-047598)).

FIG. 5 is a partial cross-sectional view showing a plasma processing apparatus used in a plasma doping method as a conventional impurity introducing method described in International Publication No. WO/2006/098109 (Japanese Patent Application No. 2005-047598). In FIG. 5, while a predetermined gas is being introduced from a gas-supply device 2 into a vacuum container 1, exhausting process is carried out by a turbo molecular pump 3 serving as an exhausting device so that the inside of the vacuum container 1 can be maintained at a predetermined pressure by a pressure-adjusting valve 4. By supplying a high-frequency power of 13.56 MHz to a coil 8 placed near a dielectric window 7 opposing a sample electrode 6 using a high-frequency power supply 5, an inductive coupling type plasma can be generated in the vacuum container 1. A silicon substrate 9 serving as a sample is placed on the sample electrode 6. A high-frequency power supply 10 for supplying a high-frequency power to the sample electrode 6 is further installed, which functions as a voltage source for controlling the electric potential of the sample electrode 6 such that the substrate 9 serving as the sample is allowed to have a negative electric potential relative to the plasma.

In this manner, ions in the plasma are accelerated toward the surface of the silicon substrate 9 serving as the sample so as to collide therewith, and an impurity is introduced into the silicon substrate 9. The gas supplied from the gas-supply device 2 is exhausted from an exhaust outlet 11 to the pump 3. The turbo molecular pump 3 and the exhaust outlet 11 are placed right below the sample electrode 6. The sample electrode 6 is a mount having a substantially round shape on which the substrate 9 is placed.

The plasma processing apparatus described in the above International Publication No. WO/2006/098109 (Japanese Patent Application No. 2005-047598) is provided with an electron beam irradiation device 12, an X-ray analyzer 13, and an X-ray detector 14, which are used for calculating an impurity concentration (dose amount) introduced into the surface of the substrate 9, an electron beam introducing hole 16 used for introducing an electron beam 15 into the vacuum container 1, and an X-ray transmitting window 18 for allowing an X-ray 17 to pass therethrough. The electron beam 15 is introduced into the vacuum container 1 from the electron beam irradiation device 12 through the electron beam introducing hole 16. When the substrate 9 is irradiated with the electron beam 15, an X-ray 17 is discharged from the substrate 9. The dose of the X-ray 17 discharged from the substrate 9 is detected using a detector constructed by the X-ray analyzer 13 and the X-ray detector 14 through the X-ray transmitting window 18, so that the impurity concentration (dose amount) introduced into the surface of the substrate 9 can be measured. In this manner, by measuring the dose amount of the substrate 9 after plasma doping in the vacuum container same as the vacuum container 1 used for introducing the impurity, it is possible to lower the defective product rate, and also to reduce the installation area of the device. A strut 19 is used for securing the sample electrode 6 onto the vacuum container 1.

However, upon processing products by continuously discharging plasma in a factory, in a case where plasma doping process is carried out repeatedly for a long period of time using the conventional plasma processing apparatus of the above International Publication No. WO/2006/098109 (Japanese Patent Application No. 2005-047598), issues arise that the period of time required for measuring the dose amount is extremely prolonged to cause reduction in the production throughput.

### SUMMARY OF THE INVENTION

In view of the above conventional issues, it is an object of the present invention to provide a plasma doping apparatus that is provided with a measuring device for inspecting a dose amount in a vacuum container in which plasma doping process is carried out, so that, upon processing products by continuously discharging plasma in a factory, it becomes possible to reduce the defective product rate while maintaining a high throughput for a long period of time.

In order to achieve the above-mentioned object, the present inventors have examined reasons why the conventional plasma doping apparatus has failed to maintain a good non-defective unit rate for a product while maintaining a high throughput for a long period of time, and have come to the following findings.

During the examination on the long-term reproducibility of plasma doping, the present inventors have found issues to be solved by the present invention. Thus, the issues that have hardly been noticed conventionally can be easily recognized.

When plasma doping process is carried out repeatedly for a long period of time using the conventional plasma doping apparatus of the above International Publication No. WO/2006/098109 (Japanese Patent Application No. 2005-047598), plasma P invades into the electron beam irradiation device 12 through the electron beam introducing hole 16 (see FIG. 7B) that is formed in the dielectric window 7 and is used for introducing an electron beam 15 into the vacuum container 1, thereby causing films containing the impurity in the plasma to be formed in the electron beam irradiation device 12. This phenomenon is described in detail with reference to FIG. 6. FIG. 6 is a partial cross-sectional view for describing in detail the electron beam irradiation device 12 and the electron beam introducing hole 16 of the conventional plasma doping apparatus. As shown in FIG. 6, a filament 12A used for generating electrons and an accelerator 12B for accelerating the generated electrons are installed in the electron beam irradiation device 12. Since the diameter of the electron beam introducing hole 16 is very large (about 40 mm, as will be described later) in the conventional plasma doping apparatus, the plasma tends to invade into the electron beam irradiation device 12 through the electron beam introducing hole 16. Consequently, the films containing the impurity adhere to the filament 12A and the accelerator 12B in the electron beam irradiation device 12. Because of such adhesion, electrons discharged from the filament 12A are intervened with the films containing the impurity thereby to cause reduction in the number of discharged electrons, and a subsequent attenuation in the intensity of the electron beam 15. It is thus found that the phenomenon described above causes the issues with the conventional plasma doping apparatus of the above International Publication No. WO/2006/098109 (Japanese Patent Application No. 2005-047598) that the period of time required for measurements on the dose amount is extremely prolonged to subsequently cause reduction in the production throughput.

Based upon the above-mentioned findings, the inventors of the present invention have devised a plasma doping apparatus, which, even in a case where plasma doping process is carried out repeatedly for a long period of time upon processing products by continuously discharging plasma in a factory, can maintain the short period of time required for the measurements on the dose amount while maintaining a high throughput for a long period of time, and consequently reduce the defective product rate.

In order to achieve the objects, the present invention has the following arrangements.

According to a first aspect of the present invention, there is provided a plasma doping apparatus comprising:

a vacuum container;

a sample electrode placed in the vacuum container and allowing a substrate to be mounted thereon;

a high-frequency power supply for applying a high-frequency power to the sample electrode;

a gas exhaust device for exhausting the vacuum container;

a gas-supply device for supplying a gas to the vacuum container;

a plasma irradiation device for directly applying a plasma to the substrate in the vacuum container;

an electron beam irradiation device for applying an electron beam toward the substrate;

an electron beam introducing tube, placed in the vacuum container, for transporting the electron beam applied from the electron beam irradiation device toward the substrate; and

an inspection device for measuring an X-ray discharged from the substrate, wherein.

On an upper wall of the vacuum container opposing the sample electrode, a plasma-invasion prevention-and-electron beam introducing hole is provided, which is communicated with the electron beam introducing tube, for introducing the electron beam toward the substrate in the vacuum container, and supposing that a Debye length of the plasma is set to λ_{d} and that a thickness of a sheath is set to S_{d}, the electron beam introducing hole has a diameter D satisfying a following equation: D≦2λ_{d}+2S_{d}.

With this arrangement, it is possible to achieve a superior effect that the period of time required for measuring the dose amount can be maintained short for a long period of time, upon processing products by continuously discharging plasma in a factory.

According to a second aspect of the present invention, there is provided the plasma doping apparatus according to the first aspect, wherein the diameter D of the electron beam introducing hole is set to 0.05 mm or more to 5 mm or less.

In a case where the diameter D of the electron beam introducing hole is less than 0.05 mm, it becomes difficult to transmit an electron beam with a low energy, resulting in difficulty in measuring the dose amount. In contrast, in a case where the diameter D of the electron beam introducing hole is larger than 5 mm, plasma tends to invade into the electron beam irradiation device through the electron beam introducing hole, resulting in issues that films containing an impurity adhere to the inside of the electron beam introducing hole and the inside of the electron beam irradiation device. In a case where the diameter D of the electron beam introducing hole is set to 0.05 mm to 5 mm, since an electron beam with a low energy can be easily transmitted, as well as since no plasma is allowed to invade into the electron beam introducing hole, no film containing an impurity adhere to the inside of the electron beam introducing hole or the inside of the electron beam irradiation device, thereby making it possible to provide a desirable structure. With this arrangement, it is possible to achieve a superior effect that the period of time required for measuring the dose amount can be maintained short for a long period of time, upon processing products by continuously discharging plasma in a factory, even under a wide range of plasma conditions.

According to a third aspect of the present invention, there is provided the plasma doping apparatus according to the first aspect, wherein on an inner wall face of an X-ray transmitting window that is formed on the vacuum container and allows the X-ray to be transmitted out of the vacuum container, a shutter is provided for opening and closing the X-ray transmitting window.

With this arrangement, while the plasma is being generated, the shutter can be located at a closed position for covering the X-ray transmitting window so that it is possible to prevent a film containing an impurity from being formed on the X-ray transmitting window, and consequently to prevent the dose amount of the X-ray from being attenuated by the film containing an impurity. Therefore, it becomes possible to achieve a superior effect that the period of time required for measuring the dose amount can be maintained short for a long period of time.

According to a fourth aspect of the present invention, there is provided the plasma doping apparatus according to the first aspect, wherein the electron beam introducing tube has a double structure provided with an outside tube and an inside tube, with the outside tube being made of metal.

With this arrangement, since the materials can be changed between the inside and the outside of the electron beam introducing tube, the electric potential between a filament and the substrate can be easily controlled by the materials, so that the electron beam can be desirably transported easily without causing reduction in the intensity of the electron beam. Moreover, since it is possible to reduce changes in the electric field in the electron beam introducing tube, which are caused by electromagnetic waves generated from a high-frequency power supply matching device, a coil, and the like placed on the periphery of the electron beam introducing tube, so that it is possible to achieve a superior effect that the substrate can be irradiated with the electron beam without causing reduction in its intensity thereof.

According to a fifth aspect of the present invention, there is provided the plasma doping apparatus according to the fourth aspect, wherein the metal forming the outside tube of the electron beam introducing tube is stainless copper.

With this arrangement, it becomes possible to desirably reduce changes in the electric field in the electron beam introducing tube being caused by the electromagnetic waves generated from the high-frequency power supply matching device, the coil, and the like placed on the periphery of the electron beam introducing tube, and also to desirably prevent corrosion due to a gas.

According to a sixth aspect of the present invention, there is provided the plasma doping apparatus according to the fourth aspect, wherein the inside tube of the electron beam introducing tube is made of an insulator.

With this arrangement, since a component of the outside metal can be prevented from being mixed into the vacuum container, it becomes possible to further desirably reduce metal contamination.

According to a seventh aspect of the present invention, there is provided the plasma doping apparatus according to the first aspect, wherein the electron beam has an accelerating energy in a range of from 50 eV to 10 keV.

In a case where the accelerating energy of the electron beam is less than 50 eV, it becomes difficult to apply the electron beam perpendicularly to the surface of the substrate to cause a serious reduction in the intensity of the X-ray to be discharged, resulting in an issue of failing to obtain a sufficient detection sensitivity. In contrast, in a case where the accelerating energy of the electron beam is 10 keV or more, since the intensity of the X-ray discharged from a region deeper than the region to be desirably measured becomes stronger, with the intensity of the X-ray discharged from a shallower region to be desirably measured in reality being made relatively smaller, an issue arises that it becomes difficult to accurately evaluate the shallower region to be desirably measured in reality.

In a case where the accelerating energy of the electron beam 34 is set to 50 eV to 10 keV, the intensity of the X-ray discharged from the shallower region to be desirably measured in reality is made sufficiently greater, while the intensity of the X-ray discharged from the deeper region that is not intended to be measured can be suppressed, so that it becomes possible to desirably carry out accurate measurement.

In accordance with the present invention, it becomes possible to provide a plasma doping apparatus that comprises a measuring device for inspecting the dose amount in a vacuum container used for carrying out plasma doping process so that, upon processing products by continuously discharging plasma in a factory, it is possible to reduce the defective product rate while maintaining a high throughput for a long period of time

### BRIEF DESCRIPTION OF THE DRAWINGS

These and other aspects and features of the present invention will become clear from the following description taken in conjunction with the preferred embodiments thereof with reference to the accompanying drawings, in which.

FIG. 1A is a partial cross-sectional view in a state where a shutter is located at a closed position in a plasma doping apparatus in accordance with one embodiment of the present invention;

FIG. 1B is a partial cross-sectional view in a state where the shutter is located as an open position in the plasma doping apparatus in accordance with the embodiment of the present invention;

FIG. 1C is a partial cross-sectional view of an inside of an electron beam irradiation device in the plasma doping apparatus in accordance with the embodiment of the present invention;

FIG. 2 is a view for describing a diameter D of an electron beam introducing hole that is determined as conditions for obtaining effects of the present invention, supposing that the electron beam introducing hole has the diameter D, a sheath has a thickness S_{d} from an inner side face of the electron beam introducing hole, and plasma has a Debye length λ_{d}, in the plasma doping apparatus of the embodiment of the present invention;

FIG. 3A is a graph showing changes in throughput in the plasma doping apparatus of the embodiment of the present invention, in a case where processes S1A to S4A are repeated with the axis of abscissas indicating the number of plasma doping process (the number of repeated cycles with the processes S1A to S4A being defined as one cycle);

FIG. 3B is a graph showing changes in throughput in a comparative example, in a case where processes S1B to S4B are repeated, with the axis of abscissas indicating the number of plasma doping operations (the number of repeated cycles with the processes S1B to S4B being defined as one cycle);

FIG. 4A is a graph indicating that, in the plasma doping apparatus of the embodiment of the present invention, the period of time required for the process S2A is maintained constant without any change from the initial stage, even when the number of repeated cycles of plasma doping process is increased;

FIG. 4B is a graph showing the relationship between the number of repeated cycles of plasma doping process and the period of time required for the process S2B in the comparative example;

FIG. 5 is a partial cross-sectional view of a plasma processing apparatus for use in a plasma doping method as a conventional impurity introducing method described in International Publication No. WO/2006/098109 (Japanese Patent Application No. 2005-047598);

FIG. 6 is a partial cross-sectional view for describing in detail an electron beam irradiation device and an electron beam introducing hole of a conventional plasma doping apparatus;

FIG. 7A is a view for describing a state where, in the plasma doping apparatus of the embodiment of the present invention, no plasma is allowed to invade into the electron beam irradiation device through the electron beam introducing hole; and

FIG. 7B is a view for describing a state where plasma invades into an electron beam irradiation device through an electron beam introducing hole in the comparative example.

### DETAILED DESCRIPTION OF THE PREFERRED EMBODIMENTS

Before the description of the present invention proceeds, it is to be noted that like parts are designated by like reference numerals throughout the accompanying drawings.

Referring to drawings, described in detail below are embodiments of the present invention.

### Embodiment

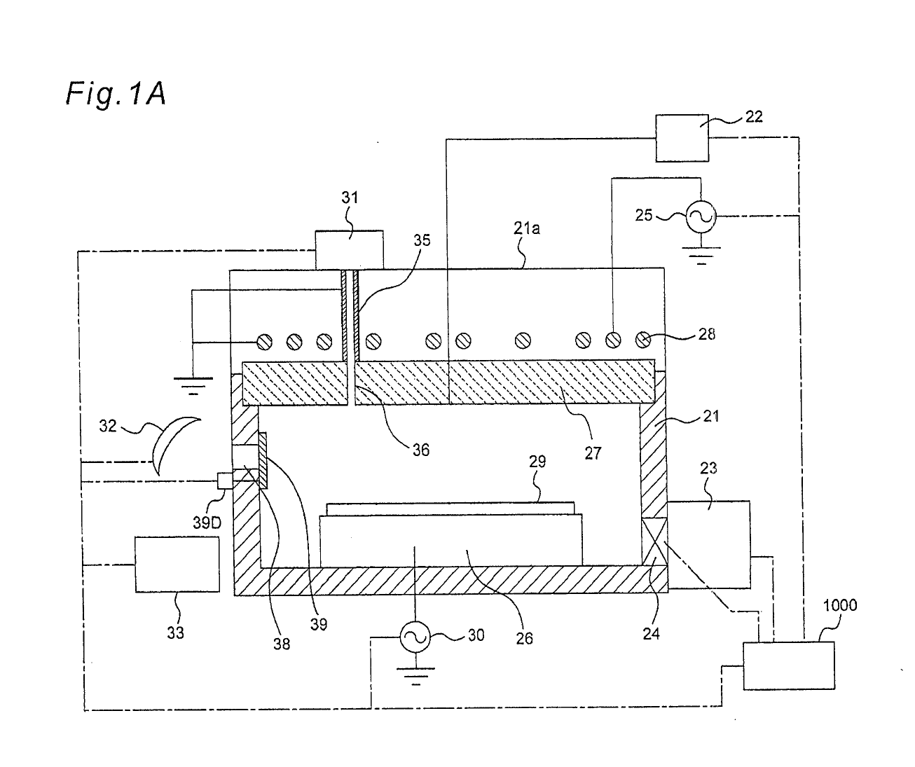

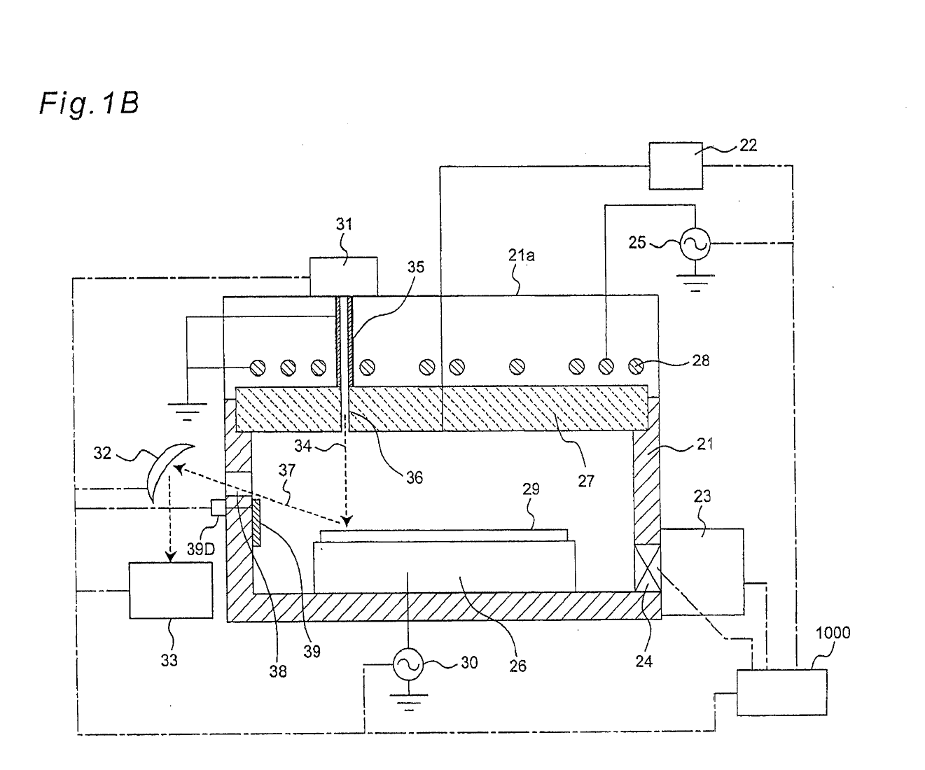

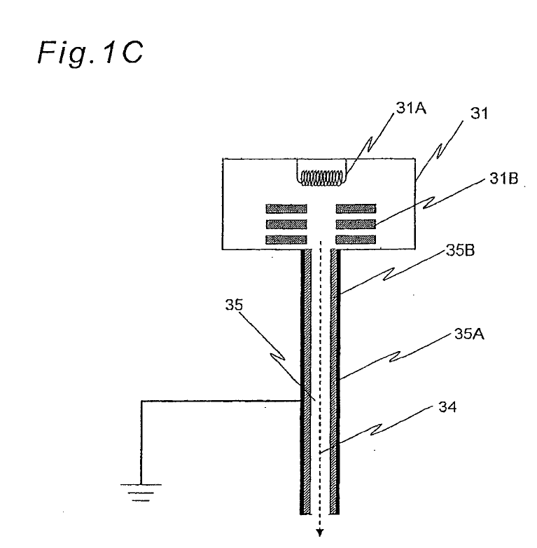

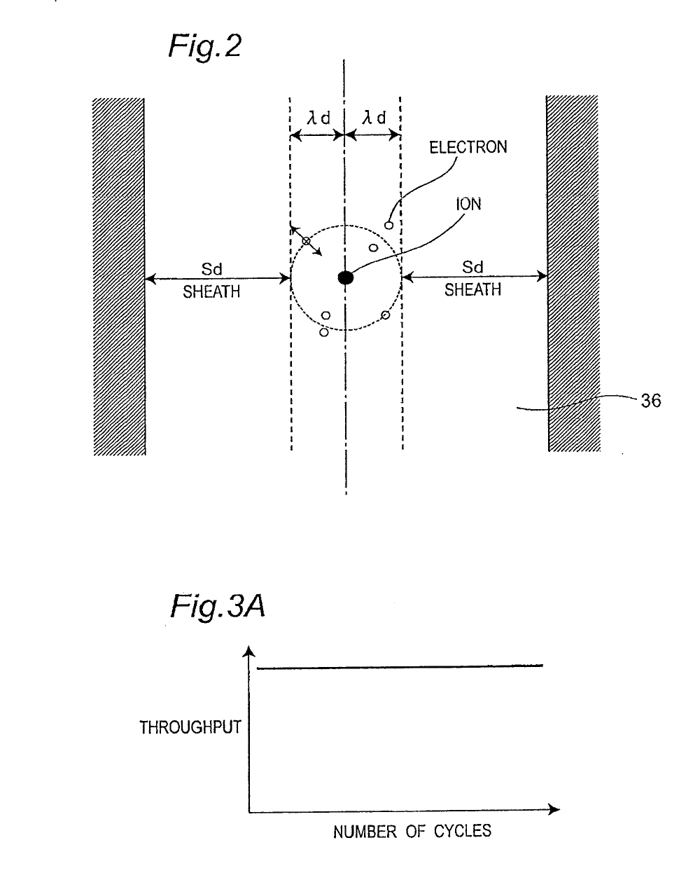

Referring to FIGS. 1A to 1C and FIG. 2, described below is a plasma doping apparatus in accordance with an embodiment of the present invention.

FIGS. 1A and 1B are partial cross-sectional views respectively showing a plasma doping apparatus used in one embodiment of the present invention. FIG. 1A shows a state where the shutter 39 to be described later is located at a closed position, and FIG. 1B shows a state where the shutter 39 is located at an open position, respectively.

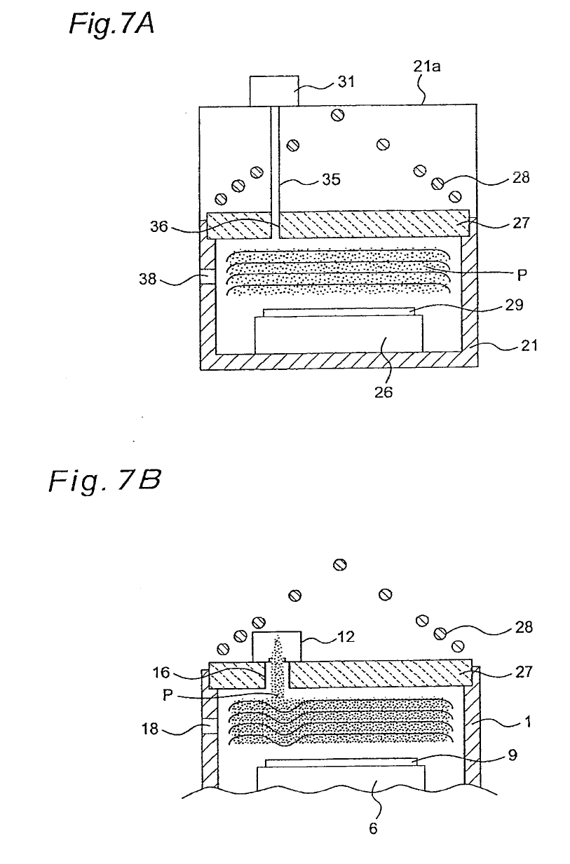

In FIGS. 1A and 1B, while B₂H₆ diluted with He or the like, which serves as a material gas, is being introduced into a vacuum container 21 configuring a vacuum chamber from a gas-supply device 22, exhausting process is carried out by a turbo molecular pump 23 serving as one example of an exhausting device, so that the inside of the vacuum container 21 can be maintained at a predetermined pressure using a pressure-adjusting valve 24. By supplying, using a high-frequency power supply 25, a high-frequency power of 13.56 MHz to a coil 28 that opposes a sample electrode 26 and that is placed outside the vacuum container 21 near a top plate 27 as one example of an upper wall of the vacuum container 21, a plasma is generated in the vacuum container 21. One example of a plasma irradiation device is formed by the high-frequency power supply 25 and the coil 28. A silicon substrate 29 serving as one example of a sample is mounted on the sample electrode 26 placed on the bottom face of the vacuum container 21 with an insulating member interposed therebetween. Moreover, a high-frequency power supply 30 for supplying a high-frequency power to the sample electrode 26 is placed outside the vacuum container 21, which functions as a voltage source for controlling the electric potential of the sample electrode 26 such that the substrate 29 serving as one example of the sample is allowed to have a negative electric potential relative to plasma. A control device 1000 is connected with the gas-supply device 22, the turbo molecular pump 23, the pressure-adjusting valve 24, the high-frequency power supply 25, an electron beam irradiation device 31, an X-ray analyzer 32, an X-ray detector 33, and a shutter open/close driving device 39D, which are to be described later, and controls the respective operations thereof. The shape of the coil 28 is not limited to a flat-plate shape as shown in FIG. 1A and the like, but may be formed in a dome shape as shown in FIG. 7A.

In this structure, under control of the control device 1000, while plasma is being directly made in contact with the silicon substrate 29, ions in the plasma are accelerated toward the surface of the silicon substrate 29 serving as one example of the sample to collide therewith, so that an impurity such as boron can be introduced into the surface of the substrate 29. Since the plasma is directly made in contact with the silicon substrate 29, the impurity such as boron can be introduced into the surface of the substrate 29 from ions as well as from a form of a gas and a radical. One of the features of the plasma doping apparatus according to the embodiment of the present invention is that plasma is directly applied to the substrate 29, without the necessity of extracting only ions from a plasma as in an ion shower device so as to separate ions from a gas and a radical, or without the necessity of separating only desired ions using a mass analyzer from a plurality of kinds of ions that are included in the plasma as in an ion injection device. With this arrangement, since all the impurity atoms that are included in the plasma can be introduced into the substrate 29 not only from ions but also from a form of a gas and a radical, it is possible to introduce the impurity into the substrate 29 with high efficiency, and consequently to achieve a superior effect that the throughput is made extremely faster.

Moreover, the plasma doping apparatus used in the embodiment of the present invention is provided with the electron beam irradiation device 31, the X-ray analyzer 32 and the X-ray detector 33, which are used for measuring the dose amount of an impurity such as boron introduced into the surface of the substrate 29. FIG. 1C is a partial cross-sectional view showing the inside of the electron beam irradiation device 31. The electron beam irradiation device 31 is preferably disposed on the top face of a casing 21a of the vacuum container 21, above the top (the uppermost portion) of the coil 28 placed on the outer face of the top plate 27 of the vacuum container 21 as well as outside the vacuum container 21, so that an electric field generated by electromagnetic waves generated from the matching device of the high-frequency power supply 25, the coil 28, and the like, is made so as not to influence the operations of the electron beam irradiation device 31. A filament 31A for generating electrons and an accelerator 31B for accelerating the electrons generated by the filament 31A are installed in the electron beam irradiation device 31. The electrons generated by the filament 31A in the electron beam irradiation device 31 are accelerated by applying a voltage to the electrode of the accelerator 31B, and are allowed to form an electron beam 34. The electron beam 34 is transmitted in an electron beam introducing tube 35. The electron beam introducing tube 35 is allowed to communicate with an electron bean introducing hole 36 formed through the top plate 27. This electron beam introducing hole 36 has functions for introducing the electron beam 34 transmitted from the electron beam introducing tube 35 toward the substrate 29 in the vacuum container 21, and for preventing plasma in the vacuum container 21 from invading into the electron beam introducing tube 35. The electron beam introducing tube 35 and the electron beam introducing hole 36 are respectively disposed along an axial line perpendicular to the surface of the substrate 29 placed on the sample electrode 26. Thus, the electron beam 34 irradiated from the electron beam irradiation device 31 is allowed to pass through the electron beam introducing tube 35 and the electron beam introducing hole 36, and to enter the vacuum container 21 so that the substrate 29 is irradiated therewith in a direction perpendicular to the surface of the substrate 29 placed on the sample electrode 26. The electron beam introducing tube 35 is made of stainless copper or the like, so as to reduce, in accordance with the static electricity shielding principle, changes in electric field in the electron beam introducing tube 35 generated by electromagnetic waves generated from the matching device of the high-frequency power supply 25, the coil 28, and the like placed in the vicinity of the electron beam introducing tube 35. Therefore, the electron beam introducing tube 35 is preferably made of a material that can reduce the changes in electric field in the electron beam introducing tube 35 generated by the electromagnetic waves, as well as is resistant to a material gas. As a result, the electron beam introducing tube 35 exerts a function for protecting the electron beam 34 from the changes in electromagnetic waves. Moreover, stainless copper is desirably used since it is hardly corroded even in a case of being made in contact with the material gas supplied from the gas-supply device 22. Upon irradiation of the silicon substrate 29 with the electron beam 34, the impurity element introduced into the surface of the silicon substrate 29, is excited. For example, K-nuclear electrons of the boron element serving as the impurity are emitted from the atoms by the electron beam. In this case, during process in which L-nuclear electrons fall on the K-nucleus to be alleviated, an X-ray 37 having energy corresponding to the energy level difference between the L nucleus and K nucleus is emitted. In the case of boron, the wavelength of the X-ray 37 is about 65 angstroms. By detecting the dose of this X-ray 37 using the detector configured by the X-ray analyzer 32 and the X-ray detector 33 through the X-ray transmitting window 38 provided on the side wall of the vacuum container 21, the dose amount thereof introduced into the surface of the silicon substrate 29 can be measured. In the present embodiment, the accelerating energy of the electron beam 34 is set to 500 eV.

The electron beam 34 is introduced into the vacuum container 21 through the electron beam introducing tube 35 and the electron beam introducing hole 36, and the silicon substrate 29 is irradiated with the electron beam 34.

The feature of the embodiment of the present invention is to set the diameter of the electron beam introducing hole 36 within a fixed numeric value range. This feature is described below in detail. In one specific example of the present embodiment, the diameter of the electron beam introducing hole 36 is set to 5 mm. Moreover, in this case, the thickness of the top plate 27 is set to 5 cm, and the height from the top plate 27 to the upper face of the casing 21a of the vacuum container 21 is set to 10 cm.

As shown in FIG. 2, conditions for obtaining the effects of the present invention are set so that, supposing that the electron beam introducing hole 36 has the diameter D, the sheath has the thickness S_{d} in the electron beam introducing hole 36 from the inner side face, and plasma has the Debye length λ_{d}, the diameter D of the electron beam introducing hole satisfies the following Equation 1:

### [Equation 1]

D≦2λ_{d}+2S_{d} (1)

The reason therefor is described in detail as follows.

In a case where no plasma is allowed to invade into the electron beam introducing hole 36, the effects of the present invention can be obtained since there is no film containing the impurity being deposited in the electron beam irradiation device 31 for applying the electron beam 34. Therefore, the conditions for achieving the effects of the present invention correspond to conditions that prevent plasma from invading into the electron beam introducing hole 36. The conditions required for allowing the plasma to invade into the electron beam introducing hole 36 are, as shown in FIG. 2, to maintain a length two times as long as the Debye length on the periphery of an ion located in the center, and also to further maintain a length two times as long as the thickness S_{d} of the sheath on the periphery thereof.

These points are further described in detail referring to FIG. 2. FIG. 2 is a view for describing one of the conditions required for allowing plasma to invade into the electron beam introducing hole 36. In the plasma, electrons and ions tend to maintain electrically neutral states. The Debye length λ_{d} refers to a minimum length in which a group of positive and negative charged electrons can be regarded as electrically neutral. That is, with respect to the ions and the electrons in the plasma, when an attracting force between a positive charge of ions and a negative charge of electrons is balanced with a departing force due to thermal movements by Coulomb force, the average value among the relative distances between the two positive and negative charges is defined as the Debye length λ_{d}. Consequently, even in a case where an isolated ion is located just in the center of the electron beam introducing hole 36, unless there is a space having a radius of λ_{d} with the ion located in the center, that is, unless there is a space having a length two times as long as the Debye length λ_{d}, the plasma is no longer maintained in the neutral state, thereby failing to maintain the plasma. In other words, unless there is a space having at least the diameter D equal to 2 λ_{d}, it is impossible to keep the group of positive and negative charged electrons in the neutral state, thereby failing to maintain the plasma. Moreover, when an insulator or a conductor is inserted in the plasma, a charged layer, referred to as the sheath, is generated between the inserted insulator or conductor and the plasma. Description will be given to the is fact that, in order to maintain the plasma, in addition to the space having at least the diameter D equal to 2 λd, a space at least two times as wide as the sheath is further required. First, in a case of a gap between the insulator and the plasma, since no DC current is allowed to flow between the insulator and the plasma, the numbers of electrons and ions that are flying per unit time need to be made equal to each other. However, since the speed of electrons is extremely faster than the speed of ions, the electrons more than the ions are allowed to reach the surface of the insulator. Therefore, excessive electrons are located on the surface to form a negative electric field near the surface, with a result that charging proceeds up to a state where the electron current and the ion current are made equal to each other. On the other hand, in a case of a gap between the conductor and the plasma, different circumstances are caused depending on states where the electric potential of the conductor is higher than that of the plasma and where it is lower than that of the plasma. In the case where the electric potential of the conductor is higher than the electric potential of the plasma, since electrons are attracted while ions are expelled, a charged layer only by electrons is formed. In contrast, in the case where the electric potential of the conductor is lower than the electric potential of the plasma, since electrons are expelled while ions are attracted, a charged layer only by ions is formed. As described above, whether the opposing wall faces of the electron beam introducing hole or the like may be made of an insulator or of a conductor, an electric potential difference is caused between the wall face and the plasma, because of a difference in diffusing speeds between electrons and ions (the speed of electrons is much faster than the speed of ions). In order to eliminate the influence of the electric field caused by therefor and to maintain the plasma, a certain space is required between the wall face and the plasma. As has been well known, this space is referred to as the sheath. Unless there is a space to form the sheath (the space having at least the diameter D equal to 2S_{d}) in addition to the space used for maintaining the charges in the plasma in the neutral state (the space having at least the diameter D equal to 2 λ_{d}), it is impossible to shield so as not to bring into the plasma the influence of the electric potential difference caused between the wall face and the plasma, thereby failing to maintain the plasma. Therefore, as shown in FIG. 2, in order to maintain the plasma, the necessary condition is to maintain the space having at least the diameter D equal to 2S_{d} in addition to the space having at least the diameter D equal to 2λ_{d}.

In summary, in order to maintain the plasma within a space having opposing two wall faces such as in the electron beam introducing hole 36, it is necessary to provide the length twice as long as the thickness S_{d} of the sheath in addition to the length twice as long as the Debye length λ_{d}, as the distance between the opposing wall faces. In a case where the distance between the two opposing wall faces is equal to or shorter than the above, it is impossible to maintain the plasma.

Consequently, by setting the diameter D of the electron beam introducing hole 36 so as to satisfy Equation 1 in accordance with a plasma to be used, that is, so as not to satisfy the condition required for maintaining the plasma, the plasma is no longer maintained in the electron beam introducing hole 36, so that it becomes possible to prevent a film containing the impurity from adhering to the inside of the electron beam irradiation device 31 and the inside of the electron beam introducing tube 36, and consequently to obtain the effects of the present invention.

Next, the numeric value of the diameter D of the electron beam introducing hole 36 is more specifically limited.

The thickness S_{d} of the sheath and the Debye length λ_{d} take different values in accordance with a plasma to be used. Upon carrying out plasma doping process using is the plasma doping apparatus of the present invention, a typical plasma density at a portion apart from the inner wall of the vacuum container 21 by 1 cm is set in a range of from 1E6 cm⁻³ to 1E8 cm⁻³, with the electron temperature being set in a range of from 1 eV to 10 eV. Supposing that the sheath thickness S_{d} and the Debye length λ_{d} are influenced by a plasma density Ne, an electron temperature kTₑ, an ion mass mᵢ, and an electron mass mₑ, the following relational equations are satisfied.

### [Equation 2]

λ_{d}=743(kTₑ/Ne)^{0.5} (2)

### [Equation 3]

0.97(S_{d}/λ_{d})²=(eVf/kTₑ−½)^{1.5} (3)

### [Equation 4]

Vf=(kTₑ/e)·Ln[0.654(mᵢ/mₑ)^{0.5}] (4)

In a case of a typical plasma used in the present embodiment (having a plasma density ranging from 1E6 cm⁻³ to 1E8 cm⁻³ and an electron temperature ranging from 1 eV to 10 eV), in accordance with Equation 3, the sheath thick S_{d} is set from 1.94 mm to 61.3 mm and the Debye length λ_{d} is set from 0.74 mm to 23.5 mm. In this case, the minimum value of the diameter D of the electron beam introducing hole 36 that satisfies the equal sign in Equation 1 is 5.4 mm. Therefore, in a case where the diameter D is set to 5 mm or less, since no plasma P is allowed to invade into the electron beam introducing hole 36 for the reasons described earlier (see FIG. 7A), it becomes possible to prevent a film containing an impurity from adhering to the inside of the electron beam irradiation device 31, and consequently to provide a superior effect that the period of time required for measuring the dose amount can be maintained short for a long period of time even under a wide range of plasma.

Moreover, as shown in FIGS. 1A and 1B, the shutter 39 is provided on the inner wall face of the X-ray transmitting window 38. The shutter 39 is formed by a lid member that is allowed to move between a closed position (see FIG. 1A) for closing the X-ray transmitting window 38 and an open position (see FIG. 1B) for exposing the X-ray transmitting window 38 using the shutter open/close driving device 39D such as a rotation device like a motor, or a cylinder, and also has an X-ray shielding function. While generating a plasma, the shutter 39 is placed so as to locate at the closed position for covering the X-ray transmitting window 38. Such arrangement makes it possible to prevent a film containing an impurity from being formed on the X-ray transmitting window 38 so that it is possible to prevent the dose of the X-ray from being attenuated by the film containing an impurity. In contrast, while measuring the dose amount by irradiating the substrate with an X-ray, as shown in FIG. 113, the shutter 39 is moved from the closed position for covering the X-ray transmitting window 38 to the open position. Therefore, the X-ray 37 generated from the substrate 29 is allowed to pass through the X-ray transmitting window 38, without being attenuated by a film containing an impurity and without being shielded by the shutter 39, and can be measured by the X-ray detector 33 by way of the X-ray analyzer 32. Thus, it becomes possible to provide the effect that the period of time required for measuring the dose amount can be maintained short for a longer period of time.

In this device thus structured, changes in the throughput upon repeatedly producing the products were examined. The throughput was defined as the total of periods of time required for carrying out the processes S1A to S4A described below.
(Process S1A) First, the silicon substrate 29 prior to introduction of an impurity thereto is mounted on the sample electrode 26 in the vacuum container 21.
(Process S2A) Next, plasma doping process is carried out so that the impurity is introduced into the silicon substrate. Under control of the control device 1000, while B₂H₆ diluted by, for example, He, serving as a material gas, is being introduced into the vacuum container 21 from the gas-supply device 22, exhausting process is carried out by the turbo molecular pump 23 so that the inside of the vacuum container 21 is maintained at a predetermined pressure using the pressure-adjusting valve 24, and a high-frequency power of 13.56 MHz is then supplied to the coil 28 using the high-frequency power supply 25 so that a plasma is generated in the vacuum container 21. By supplying a high-frequency power onto the sample electrode 26 from the high-frequency power supply 30, the electric potential of the sample electrode 26 is controlled so as to allow the substrate 29 on the sample electrode 26 to have a negative electric potential relative to the plasma. Upon introducing the impurity into the silicon substrate by carrying out plasma doping process in this manner, as an example, discharging conditions are set so that a mixed gas obtained by diluting B₂H₆ with He is used as the material gas (process gas) to be introduced into the vacuum container 21, the concentration of B₂H₆ in the material gas is set to 3% by mass or the like, the predetermined pressure in the vacuum container 21 is set to, for example, 1 Pa, and the high-frequency power to be supplied to the coil 28 is set to, for example, 1000 w. Moreover, as an example, a discharging period of time for plasma doping is set to 60 seconds. In this case, the shutter 39 placed on the inner wall face of the X-ray transmitting window 38 is located at the closed position for closing the X-ray transmitting window 38.
(Process S3A) Next, the silicon substrate 29 is irradiated with the electron beam 34 from the electron beam irradiation device 31, and the dose amount is measured by detecting the dose of the X-ray 37 discharged from the silicon substrate 29 using the X-ray detector 33. For example, the accelerating energy of the electron beam 34 in this case is 500 eV. Upon application of the electron beam 34, the shutter 39 placed on the X-ray transmitting window 38 is located at the open position for opening the X-ray transmitting window 38.
(Process S4A) Next, the silicon substrate 29 is taken out of the vacuum container 21. In this case, under control of the control device 1000, driving operations of the gas-supply device 22, the turbo molecular pump 23, the high-frequency power supply 25, the high-frequency power supply 30, and the like are respectively stopped.

The above-mentioned operations were repeated, with the processes S1A to S4A being defined as one cycle, and the resulting changes in the throughput were measured. In the present embodiment, the discharging time for plasma doping in the process S2A was set to a constant period of time. Moreover, the periods of time required for taking out and bringing in the silicon substrate 29 in the processes S1A and S4A are respectively set to constant periods of time.

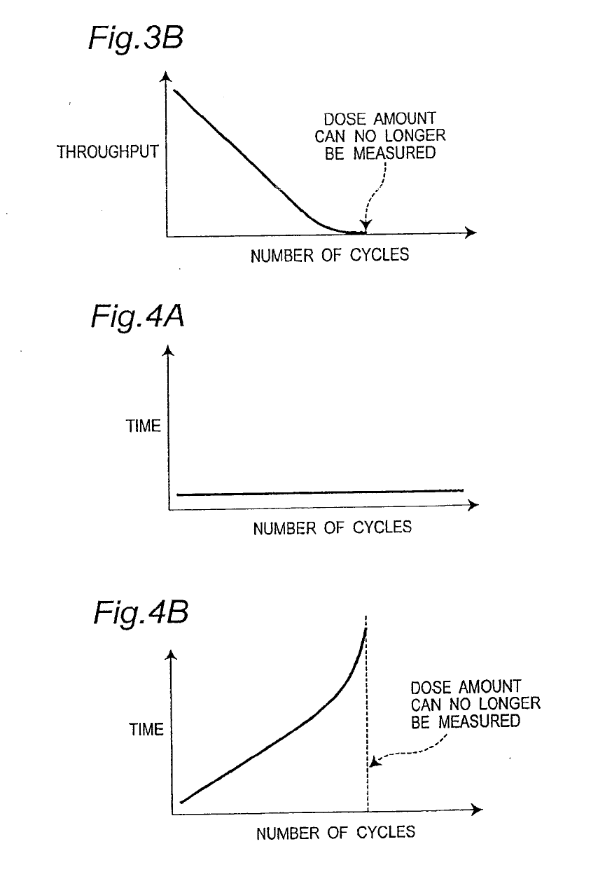

FIG. 3A is a graph indicating changes in the throughput, in a case where the processes S1A to S4A are repeated, with the axis of abscissas indicating the number of plasma doping process (the number of repeated cycles with the processes S1A to S4A being defined as one cycle). In the present embodiment, the throughput is not lowered even though plasma doping process is repeated. The periods of time respectively required for the process S1A for bringing the silicon substrate 29 into the vacuum container 21, the process S2A for introducing an impurity into the silicon substrate 29 by plasma doping process, and the process S4A for taking out the silicon substrate 29, are made constant. Moreover, as shown in FIG. 4A, even when the number of repeated cycles of plasma doping process is increased, the period of time required for carrying out the process S2A is made constant without any change from the initial stage. In this manner, since the period of time required for all the processes S1A to S4A is made constant even when the number of repeated cycles of plasma doping process is increased, it was confirmed that, in the present embodiment, the throughput was not lowered even though plasma doping process was repeated.

In other words, in a case where plasma doping process is carried out using the plasma doping apparatus according to the above-mentioned embodiment of the present invention, it is possible to achieve a superior effect that the defective product rate is reduced, while maintaining a high throughput for a long period of time (such as for several weeks or for about one month).

### COMPARATIVE EXAMPLE

Referring to drawings, described below is a plasma doping apparatus according to a comparative example.

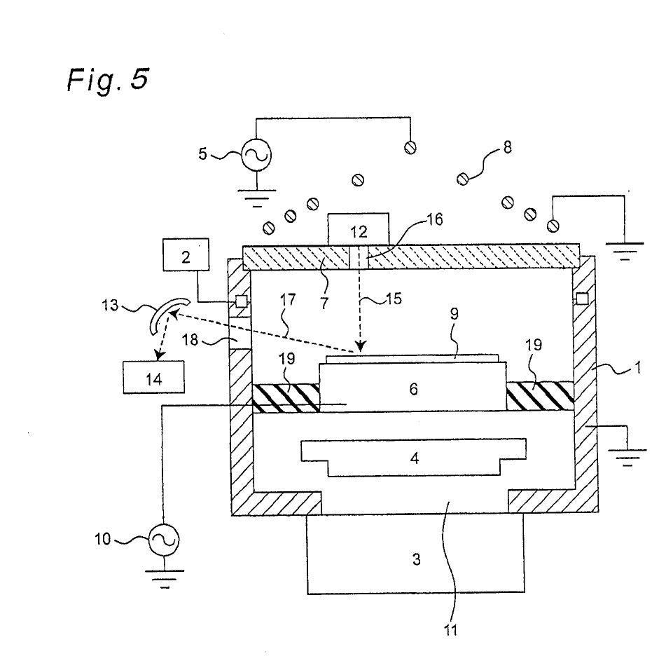

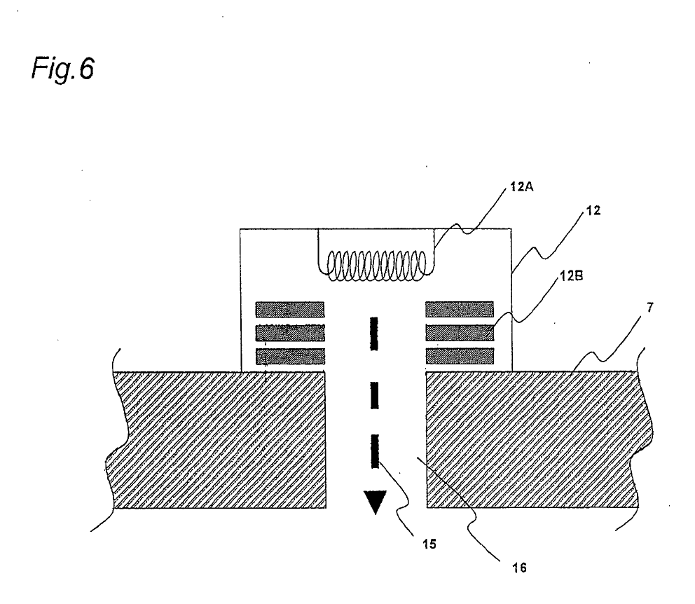

FIG. 5 is a partial cross-sectional view showing the plasma doping apparatus according to the comparative example (a plasma processing apparatus used in a plasma doping method as the conventional impurity introducing method described in International Publication No. W0/2006/098109 (Japanese Patent Application No. 2005-047598)). In FIG. 5, while a predetermined gas is being introduced into a vacuum container 1. from a gas-supply device 2, evacuation process is carried out by a turbo molecular pump 3 serving as an evacuation device so that the inside of the vacuum container 1 can be maintained at a predetermined pressure using a pressure-adjusting valve 4. By supplying a high-frequency power of 13.56 MHz to a coil 8 placed near a top plate 7 opposing a sample electrode 6 using a high-frequency power supply 5, an induction coupling type plasma can be generated in the vacuum container 1. A silicon substrate 9 serving as a sample is placed on the sample electrode 6. Moreover, a high-frequency power supply 10 for supplying a high-frequency power to the sample electrode 6 is placed, which functions as a voltage source for controlling the electric potential of the sample electrode 6 so that the substrate 9 serving as the sample is allowed to have a negative electric potential relative to the plasma.

In this manner, ions in the plasma are accelerated toward the surface of the silicon substrate 9 so as to collide therewith, and an impurity is thus introduced into the silicon substrate 9. The gas supplied from the gas-supply device 2 is evacuated to a pump 3 from an exhaust outlet 11. The turbo molecular pump 3 and the exhaust outlet 11 are placed right below the sample electrode 6. The sample electrode 6 is a mount having a substantially round shape on which the substrate 9 is placed.

The plasma doping apparatus is provided with an electron beam irradiation device 12, an X-ray analyzer 13, and an X-ray detector 14, which are used for calculating the dose amount introduced into the surface of the substrate 9, as well as an electron beam introducing hole 16 used for introducing an electron beam 15 into the vacuum container 1, and an X-ray transmitting window 18 for allowing an X-ray 17 to pass therethrough. The electron beam 15 is introduced into the vacuum container 1 from the electron beam irradiation device 12 through the electron beam introducing hole 16, and when the substrate 9 is irradiated therewith, the X-ray 17 is discharged from the substrate 9. The dose of the X-ray 17 discharged from the substrate 9 is detected using a detector composed of the X-ray analyzer 13 and the X-ray detector 14 through the X-ray transmitting window 18, so that the dose amount introduced into the surface of the substrate 9 is measured. In the device structure of the comparative example, the diameter of the electron beam introducing hole 16 is set to about 40 mm.

In such a device structure, changes in the throughput upon repeatedly producing the products were examined. The throughput was defined as the total of periods of time required for carrying out the processes S1B to S4B described below.
(Process S1B) First, the silicon substrate 9 prior to introduction of an impurity thereinto is mounted on the sample electrode 6 in the vacuum container 1.
(Process S2B) Next, plasma doping process is carried out so that the impurity is introduced into the silicon substrate 9. The plasma discharging conditions in this case are set so that a mixed gas obtained by diluting B₂H₆ with He, for example, is used as the material gas (process gas) to be introduced into the vacuum container 1, the concentration of B₂H₆ in the material gas is set to 3% by mass or the like, the predetermined pressure in the vacuum container 1 is set to, for example, 1 Pa, and the high-frequency power to be supplied to the coil 8 is set to, for example, 1000 W. Moreover, the discharging period of time for plasma doping is set to 60 seconds similarly to the examination of the throughput in the aforementioned embodiment of the present invention. The dose amount to be introduced into the silicon substrate 9 is also set to be the same as that of the embodiment of the present invention. (Process S3B) Next, the silicon substrate 9 is irradiated with the electron beam 15, and the dose amount is measured by measuring the dose amount of the X-ray 17 discharged from the silicon substrate 9. The accelerating energy of the electron beam 15 in this case was set to 500 eV similarly to the embodiment of the present invention. (Process S4B) Next, the silicon substrate 9 is taken out of the vacuum container 1.

The above-mentioned operations were repeated, with the processes S1B to S4B being defined as one cycle, and the resulting changes in the throughput were measured.

In the present comparative example, the discharging time for plasma doping in the process S2B was set to a constant period of time. Moreover, the periods of time required for taking out and bringing in the silicon substrate 9 in the processes S1B and S4B are respectively set to be constant.

FIG. 3B is a graph indicating changes in the throughput, in a case where the processes S1B to S4B are repeated, with the axis of abscissas indicating the number of plasma doping process (the number of repeated cycles with the processes S1B to S4B being defined as one cycle). In the present comparative example, in the case where plasma doping process was repeated, the throughput was extremely lowered. The periods of time respectively required for the process S1B for bringing the silicon substrate 9 into the vacuum container 1, the process S2B for introducing an impurity into the silicon substrate 9 in plasma doping process, and the process S4B for taking out the silicon substrate 9, are made constant. As the results of examinations carried out to find out the reasons for lowering of the throughput, it was found that the period of time required for the process S2B for measuring the dose amount was extremely prolonged when plasma doping process was repeated. FIG. 4B shows the relationship between the number of repeated cycles of plasma doping process and the period of time required for the process S2B. The reason for the prolonged period of time for the process S2B is because the plasma P invades into the electron beam irradiation device 12 through the electron beam introducing hole 16 (see FIG. 7B) to cause films containing the impurity to adhere to a filament and an accelerator placed in the electron beam irradiation device 12. As a result, electrons to be discharged from the filament are intervened with the films containing the impurity to cause reduction in the number of discharged electrons and a subsequent attenuation in the intensity of the electron beam 15, with the result that the dose of the X-ray 17 discharged from the silicon substrate 9 per unit time is reduced to prolong the period of time for measuring the dose amount Moreover, the film containing the impurity was also formed on the inner wall face of the X-ray transmitting window 17. Accordingly, the X-ray 17 is further attenuated by the films containing the impurity to cause reduction in the dose of the X-ray 17 reaching the X-ray detector 14, as another reason for the lowering of the throughput.

In the present comparative example, after repetitive plasma doping process, the products could no longer be produced at the last stage. This is because, when plasma doping process was repeated, the dose of the X-ray 17 discharged from the silicon substrate 9 was kept on decreasing due to the above-mentioned reasons, and finally becomes smaller than the lower limit value of the dose that can be detected by the. X-ray detector 14.

Therefore, in the case where plasma doping process is carried out using the device according to the present comparative example, an issue arises that the throughput is lowered in a short period of time (such as several hours) in comparison with that of the plasma doping apparatus according to the aforementioned embodiment of the present invention. The resulting serious issue is that products can no longer be produced at the last stage.

### MODIFIED EXAMPLE

The present invention is not intended to be limited by the aforementioned embodiments, but may be embodied in other various modes.

For example, as shown in FIG. 1C, the electron beam introducing tube 35 may have a double structure, composed of an outside tube 35A and an inside tube 35B, in which the outside tube 35A is made of metal, such as stainless copper, while the inside tube 35B is made of an insulator.

With such arrangement, since the materials can be changed between the inner side and the outer side of the electron beam introducing tube 35, the electric potential between the filament 31A and the substrate 29 is easily controlled by the materials, so that the electron beam 34 can be easily transported desirably without reduction in intensity of the electron beam 34. Moreover, since it is possible to reduce a change in the electric field in the electron beam introducing tube 35, which is caused by electromagnetic waves generated by the coil 28, a high-frequency power supply matching device, and the like of the high-frequency power supply 25 placed on the periphery of the electron beam introducing tube 35, thereby making it possible to achieve a superior effect that the substrate 29 is irradiated with the electron beam 34 without reduction in the intensity of the electron beam 34. Moreover, in a case where the metal of the outside tube 35A of the electron beam introducing tube 35 is prepared with stainless copper, since the change in the electric field in the electron beam introducing tube 35 described above can be reduced, and since corrosion due to the material gas supplied from the gas-supply device 22 can be prevented, such arrangement is more preferably used. Furthermore, in a case where the metal of the inside tube 35B of the electron beam introducing tube 35 is prepared with an insulator, since the metal component of the outside tube 35A can be prevented from being mixed into the vacuum container 21 so as to reduce metal corrosion, such arrangement is further preferably used.

The accelerating energy of the electron beam 34 applied from the electron beam irradiation device 31 is preferably set to 50 eV or more to 10 keV or less. In a case of the accelerating energy of the electron beam 34 being less than 50 eV, it becomes difficult to apply the electron beam 34 perpendicularly to the surface of the substrate 29, to cause a serious reduction in the intensity of the X-ray 37 to be discharged, resulting in an issue of failing to obtain a sufficient detection sensitivity. In contrast, in a case of the accelerating energy of the electron beam 34 being 10 keV or more, since the intensity of the X-ray 37 discharged from a region deeper than the region to be desirably measured becomes stronger, with the intensity of the X-ray 37 discharged from a region shallower than the region to be desirably measured in reality being made relatively smaller, an issue arises that it becomes difficult to accurately evaluate the shallower region to be desirably measured in reality. In a case where the accelerating energy of the electron beam 34 is set to 50 eV or more to 10 keV or less, the intensity of the X-ray 37 discharged from the shallower region to be desirably measured is made sufficiently greater, while suppressing the intensity of the X-ray 37 discharged from the deeper region that is not intended to be measured, so that it becomes possible to desirably carry out accurate measurement.

Among the various embodiments or modifications, by combining desired embodiments or modifications with one another on demand, it becomes possible to realize the respective effects.

The plasma doping apparatus according to the present invention is provided with a measuring device used for inspecting the dose amount in the vacuum container for carrying out plasma doping process so that, upon processing products by continuously discharging plasma in a factory, it becomes possible to reduce the defective product rate while maintaining a high throughput for a long period of time, and consequently to become useful for a semiconductor device and a manufacturing method thereof, in particular, when being used for introducing an impurity into the surface of a solid-state sample such as a semiconductor substrate.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A plasma doping apparatus comprising:
a vacuum container;
a sample electrode placed in the vacuum container and allowing a substrate to be mounted thereon;
a high-frequency power supply for applying a high-frequency power to the sample electrode;
a gas exhaust device for exhausting the vacuum container;
a gas-supply device for supplying a gas to the vacuum container;
a plasma irradiation device for directly applying a plasma to the substrate in the vacuum container;
an electron beam irradiation device for applying an electron beam toward the substrate;
an electron beam introducing tube, placed in the vacuum container, for transporting the electron beam applied from the electron beam irradiation device toward the substrate; and
an inspection device for measuring an X-ray discharged from the substrate, wherein on an upper wall of the vacuum container opposing the sample electrode, a plasma-invasion prevention-and-electron beam introducing hole is provided, which is communicated with the electron beam introducing tube, for introducing the electron beam toward the substrate in the vacuum container, and supposing that a Debye length of the plasma is set to λ_{d} and that a thickness of a sheath is set to S_{d}, the electron beam introducing hole has a diameter D satisfying a following equation: D≦2λ_{d}+2S_{d}.

2. The plasma doping apparatus according to claim 1, wherein the diameter D of the electron beam introducing hole is set to 0.05 mm or more to 5 mm or less.

3. The plasma doping apparatus according to claim 1, wherein on an inner wall face of an X-ray transmitting window that is formed on the vacuum container and allows the X-ray to be transmitted out of the vacuum container, a shutter is provided for opening and closing the X-ray transmitting window.

4. The plasma doping apparatus according to claim 1, wherein the electron beam introducing tube has a double structure provided with an outside tube and an inside tube, with the outside tube being made of metal.

5. The plasma doping apparatus according to claim 4, wherein the metal forming the outside tube of the electron beam introducing tube is stainless copper.

6. The plasma doping apparatus according to claim 4, wherein the inside tube of the electron beam introducing tube is made of an insulator.

7. The plasma doping apparatus according to claim 1, wherein the electron beam has an accelerating energy in a range of from 50 eV to 10 keV.
